(19) United States
(12) Patent Application Publication
(10) Pub. No.: US 2023/0409980 A1
(43) Pub. Date: Dec. 21, 2023

(54) DATA ANALYSIS METHOD, DATA ANALYSIS SYSTEM, AND DATA ANALYSIS SYSTEM SERVER

(71) Applicant: SHIMADZU CORPORATION, Kyoto-shi (JP)

(72) Inventors: Ryuji SAWADA, Kyoto-shi (JP); Hiroaki TSUSHIMA, Kyoto-shi (JP)

(73) Assignee: SHIMADZU CORPORATION, Kyoto-shi (JP)

(21) Appl. No.: 18/331,248

(22) Filed: Jun. 8, 2023

(30) Foreign Application Priority Data
Jun. 17, 2022 (JP) 2022-098333

(51) Int. Cl. G06N 20/00

(52) U.S. Cl. CPC G06N 20/00

(57) ABSTRACT

A data analysis method includes a storage step of storing a plurality of learning algorithm groups each including a type of measurement data, a type of analysis of the measurement data, and a learning algorithm associated with each other, a learning algorithm selection step of selecting the learning algorithm based on input information, and a trained model generation step of generating a trained model based on training data and the learning algorithm.

### CROSS-REFERENCE TO RELATED APPLICATIONS

This application claims the benefit of priority to Japanese Patent Application No. 2022-098333 filed on Jun. 17, 2022. The entire contents of this application are hereby incorporated herein by reference.

### BACKGROUND OF THE INVENTION

### Field of the Invention

The present invention relates to a data analysis method, a data analysis system, and a data analysis system server, and more particularly, it relates to a data analysis method, a data analysis system, and a data analysis system server for generating a trained model and analyzing measurement data using the generated trained model.

### Description of the Background Art

Conventionally, a data analysis method for generating a trained model and analyzing measurement data using the generated trained model is known. Such a data analysis method is disclosed in Japanese Patent Laid-Open No. 2021-064115, for example.

Japanese Patent Laid-Open No. 2021-064115 discloses a cell image analysis method including a learning model generation step for generating a learning model by performing machine learning, and an area estimation step for outputting a cell area estimation image indicating a cell area using the learning model, using a phase image for an analysis target cell as an input image.

Although not disclosed in Japanese Patent Laid-Open No. 2021-064115, specialized knowledge such as selection of a learning algorithm is required in order to generate a learning model (trained model) for analyzing measurement data such as a cell area estimation image. Thus, it is difficult for a user with low skills to generate the trained model. Therefore, it is conceivable that the user with low skills outsources the generation of the trained model. However, when the user outsources the generation of the trained model, it takes time to generate the trained model, and it disadvantageously takes time to analyze the measurement data using the trained model. Therefore, there is a demand for a data analysis method that enables even a user with low skills to easily generate a trained model and can reduce the time required to analyze measurement data using the trained model.

### SUMMARY OF THE INVENTION

The present invention is intended to solve at least one of the above problems. The present invention aims to provide a data analysis method, a data analysis system, and a data analysis system server that each enables even a user with low skills to easily generate a trained model and can reduce the time required to analyze measurement data using the trained model.

A data analysis method according to a first aspect of the present invention is implemented between a system management company and a customer who desires to acquire an analysis result of measurement data acquired from a measuring device, and includes a storage step of storing in advance a plurality of learning algorithm groups each including a type of the measurement data, a type of analysis of the measurement data, and a learning algorithm associated with each other, a training data receiving step of receiving an input of training data, an input information receiving step of receiving an input of input information including information about the type of the measurement data and information about the type of analysis of the measurement data, a learning algorithm selection step of selecting the learning algorithm to be used for learning from among the plurality of learning algorithm groups based on the input information, a trained model generation step of generating a trained model based on the training data and the selected learning algorithm, and an analysis result acquisition step of analyzing the measurement data based on the trained model and acquiring the analysis result.

A data analysis system according to a second aspect of the present invention is configured to perform data analysis between a system management company and a customer who desires to acquire an analysis result of measurement data acquired from a measuring device, and includes a server configured to generate a trained model to analyze the measurement data, and a data processor configured to request the server to analyze the measurement data. The server includes a storage configured to store in advance a plurality of learning algorithm groups each including a type of the measurement data, a type of analysis of the measurement data, and a learning algorithm associated with each other, an input receiver configured to receive an input of input information including information about the type of the measurement data and information about the type of analysis of the measurement data, and an input of training data, a learning algorithm selector configured to select the learning algorithm to be used for learning from among the plurality of learning algorithm groups based on the input information, a trained model generator configured to generate the trained model based on the training data and the selected learning algorithm, and an analysis result acquirer configured to analyze the measurement data based on the trained model generated by the trained model generator and acquire the analysis result.

A data analysis system server according to a third aspect of the present invention is configured to perform data analysis between a system management company and a customer who desires to acquire an analysis result of measurement data acquired from a measuring device, and includes a storage configured to store in advance a plurality of learning algorithm groups each including a type of the measurement data, a type of analysis of the measurement data, and a learning algorithm associated with each other, an input receiver configured to receive an input of input information including information about the type of the measurement data and information about the type of analysis of the measurement data, and an input of training data, a learning algorithm selector configured to select the learning algorithm to be used for learning from among the plurality of learning algorithm groups based on the input information, a trained model generator configured to generate the trained model based on the training data and the selected learning algorithm, and an analysis result acquirer configured to analyze the measurement data based on the trained model generated by the trained model generator and acquire the analysis result.

The data analysis method according to the first aspect of the present invention includes the storage step of storing in advance the plurality of learning algorithm groups each including the type of the measurement data, the type of analysis of the measurement data, and the learning algorithm associated with each other, the input information receiving step of receiving an input of the input information including the information about the type of the measurement data and the information about the type of analysis of the measurement data, and the learning algorithm selection step of selecting the learning algorithm to be used for learning from among the plurality of learning algorithm groups based on the input information. Accordingly, a user simply inputs the information about the type of the measurement data and the information about the type of analysis of the measurement data such that the learning algorithm suitable for the trained model to be used to analyze the measurement data is selected from among the plurality of learning algorithm groups. Therefore, even the user with low skills can easily generate the trained model without outsourcing the generation. Moreover, the trained model can be generated without being outsourced, and thus the time required to generate the trained model can be reduced. Consequently, it is possible to provide the data analysis method that enables even the user with low skills to easily generate the trained model and can reduce the time required to analyze the measurement data using the trained model.

Each of the data analysis system according to the second aspect of the present invention and the data analysis system server according to the third aspect of the present invention includes the storage configured to store in advance the plurality of learning algorithm groups each including the type of the measurement data, the type of analysis of the measurement data, and the learning algorithm associated with each other, the input receiver configured to receive an input of the input information including the information about the type of the measurement data and the information about the type of analysis of the measurement data, and an input of the training data, and the learning algorithm selector configured to select the learning algorithm to be used for learning from among the plurality of learning algorithm groups based on the input information. Accordingly, it is possible to provide the data analysis system and the data analysis system server that enables even the user with low skills to easily generate the trained model and can reduce the time required to analyze the measurement data using the trained model, similarly to the data analysis method according to the first aspect.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the overall configuration of a data analysis system according to an embodiment.

FIG. 2 is a block diagram showing the configuration of a server for data analysis according to the embodiment.

FIG. 3 is a block diagram showing the configuration of a data processor according to the embodiment.

FIG. 4 is a schematic view for illustrating a configuration that generates a trained model in the server and the data processor according to the embodiment.

FIG. 5 is a schematic view for illustrating a screen example for generating the trained model in the data processor according to the embodiment.

FIG. 6 is a block diagram for illustrating a learning algorithm group.

FIG. 7 is a matrix diagram for illustrating association of the types of measurement data, the types of analysis of measurement data, and learning algorithms.

FIG. 8 is a block diagram for illustrating a process in which a trained model generator generates a trained model.

FIG. 9 is a schematic view for illustrating a configuration that analyzes the measurement data in the server and the data processor according to the embodiment.

FIG. 10 is a schematic view for illustrating a screen example for analyzing the measurement data in the data processor according to the embodiment.

FIG. 11 is a block diagram for illustrating a data processing program group.

FIG. 12 is a matrix diagram for illustrating association of the types of measurement data, the types of analysis of measurement data, and the data processing programs.

FIG. 13 is a block diagram for illustrating analysis conditions.

FIG. 14 is a block diagram for illustrating a configuration in which an analysis result acquirer acquires an analysis result.

FIG. 15 is a flowchart for illustrating a data analysis process.

FIG. 16 is a flowchart for illustrating a trained model generation process.

FIG. 17 is a flowchart for illustrating an analysis result acquisition process.

FIG. 18 is a flowchart for illustrating a learning algorithm addition process.

FIG. 19 is a flowchart for illustrating a data processing program addition process.

FIG. 20 is a block diagram for illustrating a data processing system according to a modified example.

### DESCRIPTION OF THE PREFERRED EMBODIMENTS

An embodiment of the present invention is hereinafter described with reference to the drawings.

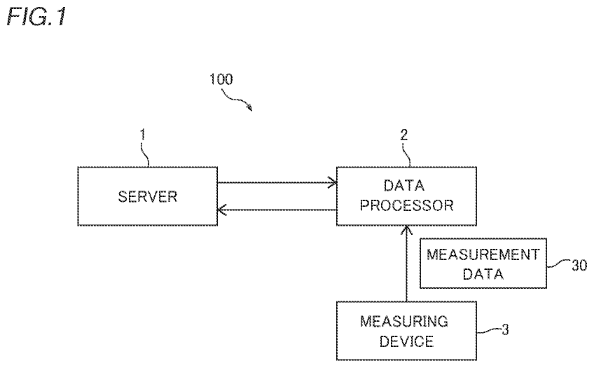

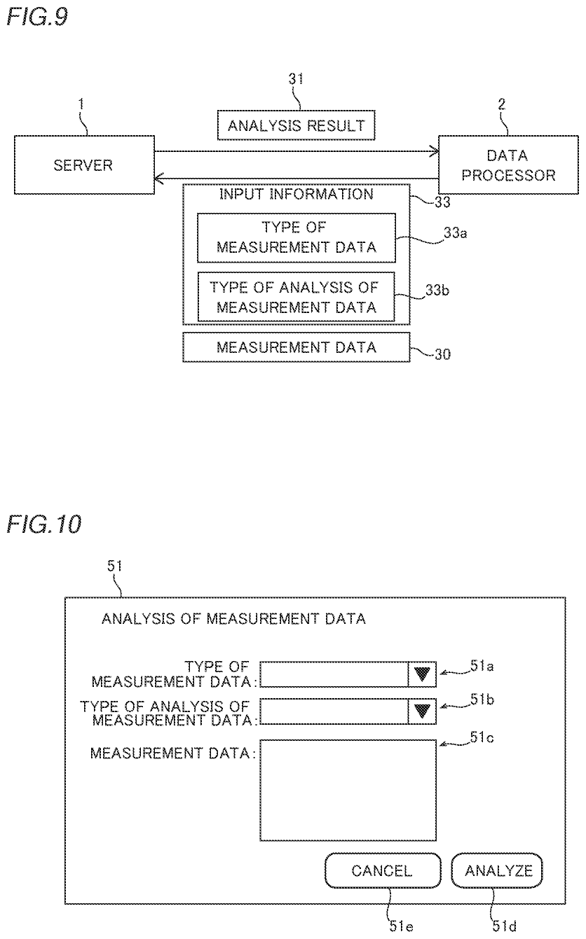

The configurations of a data analysis system 100 (see FIG. 1) that implements a data analysis method according to this embodiment and a server 1 (see FIG. 1) for data analysis are now described with reference to FIGS. 1 to 14. The data analysis method according to this embodiment is a data analysis method implemented between a system management company and a customer who desires to acquire an analysis result 31 (see FIG. 9) of measurement data 30 (see FIG. 1) acquired from a measuring device 3 (see FIG. 1). The data analysis system 100 according to this embodiment is a data analysis system that performs data analysis between the system management company and the customer who desires to acquire the analysis result 31 of the measurement data 30 acquired from the measuring device 3. The system management company may be a company that manufactures the data analysis system 100 or a company that takes an outsourcing operation and performs maintenance and inspection of the data analysis system 100.

### Configuration of Data Analysis System

As shown in FIG. 1, the data analysis system 100 includes the server 1 and a data processor 2. The data processor 2 is connected to the measuring device 3.

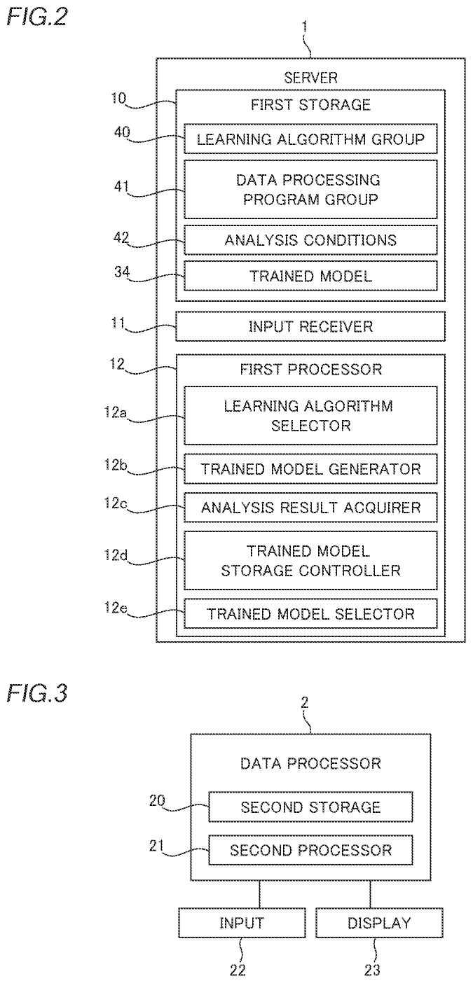

The server 1 is a data analysis system server for performing data analysis between the system management company and the customer who desires to acquire the analysis result 31 of the measurement data 30 acquired from the measuring device 3. The server 1 generates a trained model 34 (see FIG. 2) for analyzing the measurement data 30. In this embodiment, the server 1 is connected to the data processor 2 via a network. The configuration of the server 1 is described below in detail. The server 1 may be installed in a facility different from the data processor 2. That is, the data analysis system 100 may be a cloud-type system. Alternatively, the server 1 may be installed in the same facility as the data processor 2. That is, the data analysis system 100 may be an on-premise system. In this embodiment, the data analysis system 100 is an on-premise system.

The data processor 2 requests the server 1 to analyze the measurement data 30. Specifically, the data processor 2 performs a process to transmit a control signal for starting analysis of the measurement data 30 to the server 1. The data processor 2 is connected to the server 1 via the network. The data processor 2 is also connected to the measuring device 3, acquires the measurement data 30 described below from the measuring device 3, and transmits the measurement data 30 to the server 1. The data processor 2 is installed in a customer's facility. The configuration of the data processor 2 is described below in detail.

The measuring device 3 acquires the measurement data 30. The measuring device 3 is connected to the data processor 2. The measuring device 3 transmits the acquired measurement data 30 to the data processor 2. The measuring device 3 includes a measuring device that acquires the measurement data 30. The measuring device 3 may include an X-ray imaging device, a computed tomography (CT) device, a device for measuring a particle size distribution, a surface measuring device, a microscope, a liquid chromatography (LC) device, or a gas chromatography (GC) device, for example. The measuring device 3 is installed in the customer's facility.

The measurement data 30 is data acquired by the measuring device 3. The measurement data 30 is an X-ray image when the measuring device 3 is an X-ray imaging device, for example. The measurement data 30 is a tomographic image when the measuring device 3 is a CT device, for example. The measurement data 30 is particle size distribution data when the measuring device 3 is a device that measures a particle size distribution, for example. The measurement data 30 is data indicating the surface shape of an object to be measured when the measuring device 3 is a surface measuring device, for example. The measurement data 30 is an image (cell image, for example) captured by a microscope when the measuring device 3 is a microscope, for example. The measurement data 30 is a chromatogram when the measuring device 3 is an LC or GC device, for example.

As shown in FIG. 2, the server 1 includes a first storage 10, an input receiver 11, and a first processor 12.

The server 1 performs a process to generate the trained model 34 (a process to perform machine learning). The server 1 has a function of storing (accumulating) various data used when the trained model 34 is generated. The server 1 also has a function of analyzing the measurement data 30 (see FIG. 1) using the trained model 34.

The first storage 10 stores the trained model 34. The first storage 10 also stores a learning algorithm group 40. The first storage 10 also stores a data processing program group 41. The first storage 10 also stores analysis conditions 42. The first storage 10 also stores various programs executed by the first processor 12. In this embodiment, the first storage 10 stores in advance the learning algorithm group 40, the data processing program group 41, and the various programs executed by the first processor 12 when manufacturing of the data analysis system 100 is completed.

The first storage 10 stores the trained model 34 and the analysis conditions 42 ex post facto. The first storage 10 is a non-volatile storage device such as a hard disk drive (HDD) or a solid state drive (SSD), for example. The first storage 10 is an example of a “storage” in the claims. The trained model 34, the learning algorithm group 40, the data processing program group 41, and the analysis conditions 42 are described below in detail.

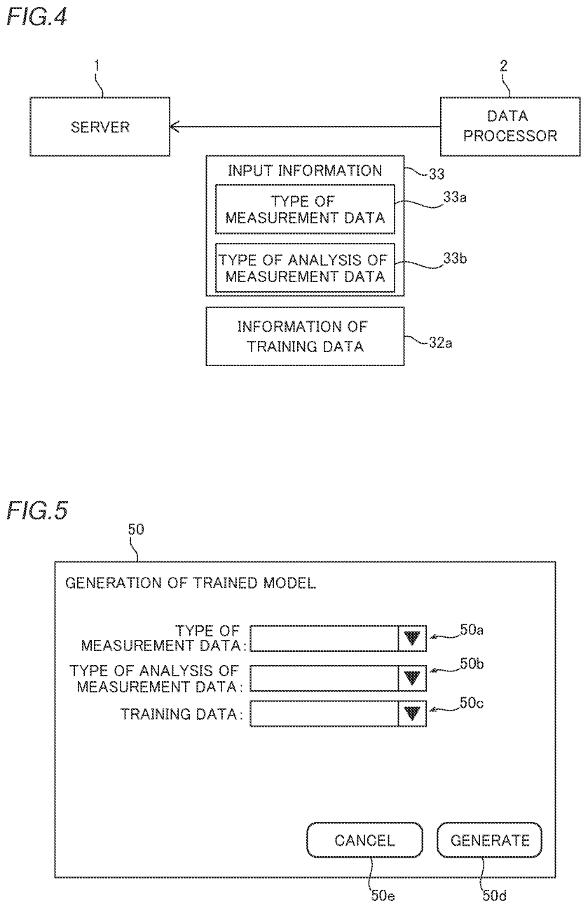

The input receiver 11 receives an input of input information 33 (see FIG. 4) described below from the data processor 2. The input receiver 11 is an input/output interface, for example.

The first processor 12 performs various controls of the server 1. The first processor 12 generates the trained model 34. The first processor 12 analyzes the measurement data 30 (see FIG. 1) and acquires the analysis result 31 (see FIG. 9). The first processor 12 includes a central processing unit (CPU), a read-only memory (ROM) and a random access memory (RAM), and a graphics processing unit (GPU) or a field-programmable gate array (FPGA) configured for image processing, for example. The first processor 12 may include circuitry instead of the CPU.

The first processor 12 also includes, as functional blocks of software (programs), a learning algorithm selector 12a, a trained model generator 12b, and an analysis result acquirer 12c. The first processor 12 also includes a trained model storage controller 12d and a trained model selector 12e. The first processor 12 functions as the learning algorithm selector 12a, the trained model generator 12b, the analysis result acquirer 12c, the trained model storage controller 12d, and the trained model selector 12e by executing various programs stored in the first storage 10. The learning algorithm selector 12a, the trained model generator 12b, the analysis result acquirer 12c, the trained model storage controller 12d, and the trained model selector 12e are individually configured as hardware by a dedicated processor (processing circuit).

The functions of the learning algorithm selector 12a, the trained model generator 12b, the analysis result acquirer 12c, the trained model storage controller 12d, and the trained model selector 12e are described below in detail.

As shown in FIG. 3, the data processor 2 includes a second storage 20 and a second processor 21. The data processor 2 also includes an input 22 and a display 23. The data processor 2 transmits a control signal for starting generation of the trained model 34 (see FIG. 2) to the server 1 (see FIG. 2) based on an operator's operation input. The data processor 2 transmits a control signal for starting analysis of the measurement data 30 (see FIG. 1) to the server 1 based on an operator's operation input.

The second storage 20 stores various programs that the second processor 21 executes. The second storage 20 is a non-volatile storage device such as an HDD or an SSD, for example.

The second processor 21 functions as a controller that performs various controls of the data processor 2 by executing various programs stored in the second storage 20. The second processor 21 includes a CPU, a ROM and a RAM, and GPU or an FPGA configured for image processing, for example. The second processor 21 may include circuitry instead of the CPU.

The input 22 is an input used when an operator inputs an operation. The input 22 includes a mouse and a keyboard, for example.

The display 23 displays the analysis result 31 (see FIG. 9) of the measurement data 30 (see FIG. 1), for example. The display 23 is a display device such as a liquid crystal monitor or an organic electro luminescence (EL) monitor, for example.

The data analysis method implemented by the data analysis system 100 (see FIG. 1) according to this embodiment is now described with reference to FIGS. 4 to 14.

The data analysis method implemented by the data analysis system 100 can be broadly divided into a method for generating the trained model 34 (see FIG. 2), and a method for analyzing the measurement data 30 (see FIG. 1) and acquiring the analysis result 31 (see FIG. 9).

### Generation of Trained Model

First, the method for the data analysis system 100 (see FIG. 1) to generate the trained model 34 (see FIG. 2) is described with reference to FIGS. 4 to 8.

The method for generating the trained model 34 includes at least a training data receiving step of receiving an input of training data 32 (see FIG. 8) and an input information receiving step of receiving an input of the input information 33.

The training data receiving step is a step of receiving an input of the training data 32. In the step of receiving an input of the training data 32, the server 1 (see FIG. 4) receives an input of the training data 32 from the data processor 2 (see FIG. 4). The server 1 stores the input training data 32 in the first storage 10 (see FIG. 2). The training data receiving step may be performed before the input information receiving step of receiving an input of the input information 33, or may be performed together with the input information receiving step. That is, the training data 32 may be input to the server 1 before the input information 33 is input, or may be input to the server 1 together with the input information 33. In this embodiment, the training data receiving step is performed before the input information receiving step. That is, the training data 32 and the input information 33 are input to the server 1 at different timings. The training data 32 is data used when a learning algorithm 40a is learned and the trained model 34 is generated. The learning algorithm 40a refers to a program used when the trained model 34 is generated. The learning algorithm 40a includes linear regression, a random forest, a neural network, and a support vector machine, for example.

The input information receiving step is a step of receiving an input of the input information 33 including information about the type 33a of measurement data 30 and information about the type 33b of analysis of the measurement data 30. As shown in FIG. 4, the server 1 receives the input information 33 from the data processor 2. The information about the type 33a of measurement data 30 refers to information indicating what type of data the measurement data 30 is, such as a “cell image” or an “X-ray image”. The information about the type 33b of analysis of the measurement data 30 refers to information indicating the type of analysis to be performed on the measurement data 30, such as “shape analysis” or “good/bad determination”.

In an example shown in FIG. 4, information 32a about the training data 32 is input to the server 1 together with the input information 33. The information 32a about the training data 32 refers to information selected by the operator as to which training data 32 is used in training of the trained model 34.

An example shown in FIG. 5 is a screen 50 for the operator to perform a process to generate the trained model 34 (see FIG. 2) in the data processor 2 (see FIG. 4).

The screen 50 for performing the process to generate the trained model 34 is displayed on the display 23 (see FIG. 3). A first selection field 50a, a second selection field 50b, a training data selection field 50c, a generate button 50d, and a cancel button 50e are displayed on the screen 50 for performing the process to generate the trained model 34.

The first selection field 50a is a selection field in which the type 33a (see FIG. 4) of measurement data 30 is selected. The first selection field 50a is a pull-down selection field, for example. Options displayed in the first selection field 50a are stored in the first storage (see FIG. 2). The first processor 12 (see FIG. 2) acquires the type 33a of measurement data 30 stored in the first storage 10 and displays it as an option in the first selection field 50a.

The second selection field 50b is a selection field in which the type 33b (see FIG. 4) of analysis of the measurement data 30 is selected. The second selection field 50b is a pull-down selection field, for example. Options displayed in the second selection field 50b are stored in the first storage 10. The first processor 12 acquires the type 33b of analysis of the measurement data 30 stored in the first storage 10 and displays it as an option in the second selection field 50b.

The training data selection field 50c is a selection field in which the training data 32 (see FIG. 8) stored in the first storage 10 is selected. The training data selection field 50c is a pull-down selection field, for example. Options displayed in the training data selection field 50c are stored in the first storage 10. The first processor 12 acquires the name of the training data 32 stored in the first storage 10 and displays it as an option in the training data selection field 50c.

The generate button 50d is a graphical user interface (GUI) push button displayed on the screen 50 for performing the process to generate the trained model 34. When the generate button 50d is pressed, the input information 33 (see FIG. 4) and the training data 32 are transmitted from the data processor 2 to the server 1 (see FIG. 4), and the process to generate the trained model 34 is started in the server 1.

The cancel button 50e is a GUI push button displayed on the screen 50 for performing the process to generate the trained model 34. When the cancel button 50e is pressed, the trained model 34 is not generated, and the screen 50 for performing the process to generate the trained model 34 is closed.

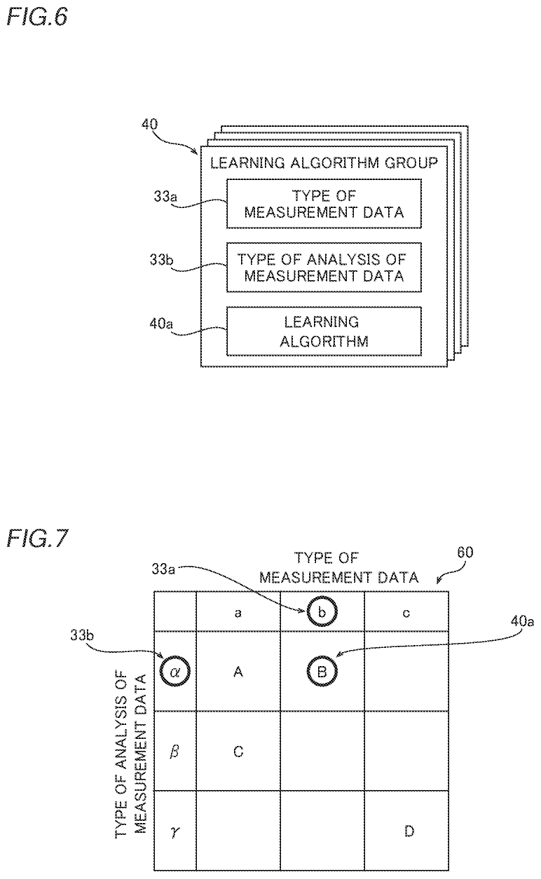

The learning algorithm 40a (see FIG. 6) used to generate the trained model 34 suitable for analyzing the measurement data 30 is learned using the training data 32 such that the trained model 34 is generated. Selection of the learning algorithm 40a requires specialized knowledge. Therefore, it is difficult for a user with low skills to generate the trained model 34 suitable for analyzing the measurement data 30.

Therefore, in this embodiment, when the trained model 34 is generated, the server 1 selects an appropriate learning algorithm 40a from the learning algorithm group 40 (see FIG. 6) according to the measurement data 30 to be analyzed.

The learning algorithm group 40 includes a plurality of learning algorithms 40a. In this embodiment, as shown in FIG. 6, the learning algorithm group 40 including the type 33a of measurement data 30 (see FIG. 1), the type 33b of analysis of the measurement data 30, and the learning algorithm 40a associated with each other is stored in the first storage 10 (see FIG. 2). The learning algorithm group 40 including the type 33a of measurement data 30, the type 33b of analysis of the measurement data 30, and the learning algorithm 40a associated with each other is stored in advance in the first storage 10. In this embodiment, the first storage 10 stores in advance a plurality of learning algorithm groups 40 for each type 33a of measurement data 30 and each type 33b of analysis of the measurement data 30. In this embodiment, the first storage 10 stores the plurality of learning algorithm groups 40 as presets. That is, the first storage 10 stores in advance the plurality of learning algorithm groups 40 when manufacturing of the data analysis system 100 is completed.

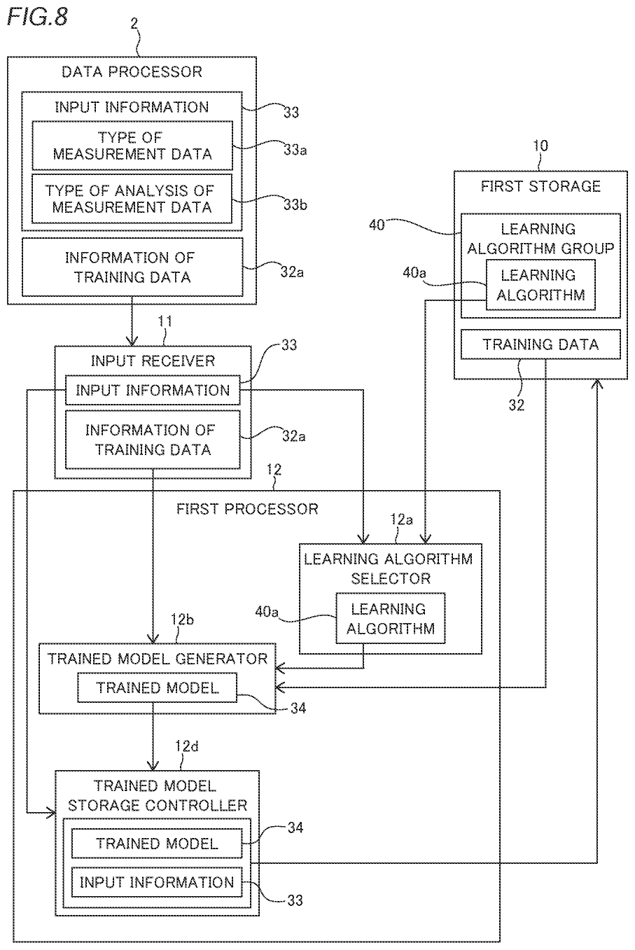

As shown in a matrix diagram 60 of FIG. 7, the learning algorithm group 40 is stored in which learning algorithms 40a have been combined with arbitrary combinations of a plurality of types 33a of measurement data 30 and a plurality of types 33b of analysis of the measurement data 30. For example, a learning algorithm 40a of “B” is associated with a combination in which the type 33a of measurement data 30 is “b” and the type 33b of analysis of the measurement data 30 is “a”. Therefore, the operator can select an appropriate learning algorithm from among the plurality of learning algorithm groups by selecting the type 33a of measurement data 30 and the type 33b of analysis of the measurement data 30. In an example shown in FIG. 7, in the matrix diagram 60, all combinations of the types 33a of measurement data 30 and the types 33b of analysis of the measurement data 30 are not associated with the learning algorithms 40a. However, the first storage 10 may store the learning algorithms 40a associated with all combinations of the types 33a of measurement data 30 and the types 33b of analysis of the measurement data 30.

In this embodiment, in addition to the previously stored (preset) learning algorithms 40a, another learning algorithm 40a can be added. Specifically, the first processor 12 (see FIG. 2) receives addition of another learning algorithm 40a associated with the type 33a of measurement data 30 and the type 33b of analysis of the measurement data 30 to the plurality of learning algorithm groups 40 stored in advance. That is, the server 1 can add (plug in) another learning algorithm 40a to the plurality of learning algorithm groups 40 stored in advance.

A process in which the first processor 12 generates the trained model 34 is now described with reference to FIG. 8.

As shown in FIG. 8, the input receiver 11 receives an input of the input information 33 including the information about the type 33a of measurement data 30 (see FIG. 1) and the information about the type 33b of analysis of the measurement data 30 from the data processor 2. The input receiver 11 outputs the input information 33 to the learning algorithm selector 12a and the trained model storage controller 12d.

The input receiver 11 receives an input of the information 32a about the training data 32. The input receiver 11 outputs the information 32a about the training data 32 to the trained model generator 12b.

The learning algorithm selector 12a selects the learning algorithm 40a to be used for learning from among the plurality of learning algorithm groups 40 based on the input information 33. Specifically, the learning algorithm selector 12a selects the learning algorithm 40a corresponding to the information about the type 33a of measurement data 30 and the information about the type 33b of analysis of the measurement data 30 from among the plurality of learning algorithm groups 40. In this embodiment, the learning algorithm selector 12a selects one learning algorithm 40a corresponding to the information about the type 33a of measurement data 30 and the information about the type 33b of analysis of the measurement data 30. The learning algorithm selector 12a outputs the selected learning algorithm 40a to the trained model generator 12b.

The trained model generator 12b generates the trained model 34 based on the training data 32 and the selected learning algorithm 40a. In this embodiment, the trained model generator 12b reads the training data 32 from the first storage 10 based on the information 32a about the training data 32. Then, the trained model generator 12b generates the trained model 34 based on the learning algorithm 40a input from the learning algorithm selector 12a and the training data 32 read from the first storage 10. The trained model generator 12b outputs the generated trained model 34 to the trained model storage controller 12d.

The trained model storage controller 12d stores the generated trained model 34, the type 33a of measurement data 30, and the type 33b of analysis of the measurement data 30 in association with each other. In this embodiment, the trained model storage controller 12d stores the type 33a of measurement data 30 and the type 33b of analysis of the measurement data 30 in association with the trained model 34 in the first storage 10.

### Analysis of Measurement Data

A method for the data analysis system 100 (see FIG. 1) to analyze the measurement data 30 (see FIG. 9) is now described with reference to FIGS. 9 to 14.

As shown in FIG. 9, the method for analyzing the measurement data 30 includes a step in which the server 1 acquires the measurement data 30 and the input information 33 including the type 33a of measurement data 30 and the type 33b of analysis of the measurement data 30 from the data processor 2. Moreover, the method for analyzing the measurement data 30 includes an analysis result acquisition step of analyzing the measurement data 30 based on the trained model 34 and acquiring the analysis result 31. The analysis result 31 can be data in various formats according to the type 33a of measurement data 30 and the type 33b of analysis of the measurement data 30. For example, the analysis result 31 may be image data. The analysis result 31 may be numerical data.

An example shown in FIG. 10 is a screen 51 for the operator to perform an operation to request an analysis process of the measurement data 30 (see FIG. 9) in the data processor 2 (see FIG. 9).

The screen 51 for performing the operation to request the analysis process of the measurement data 30 is displayed on the display 23 (see FIG. 3). A first selection field 51a, a second selection field 51b, a measurement data selection field 51c, an analyze button 51d, and a cancel button 51e are displayed on the screen 51 for performing the operation to request the analysis process of the measurement data 30.

The first selection field 51a is a selection field in which the type 33a (see FIG. 9) of measurement data 30 is selected. The first selection field 51a is a pull-down selection field, for example. Options displayed in the first selection field 51a are stored in the first storage 10. The first processor 12 (see FIG. 2) acquires the type 33a of measurement data 30 stored in the first storage 10 and displays it as an option in the first selection field 51a.

The second selection field 51b is a selection field in which the type 33b (see FIG. 9) of analysis of the measurement data 30 is selected. The second selection field 51b is a pull-down selection field, for example. Options displayed in the second selection field 51b are stored in the first storage 10. The first processor 12 acquires the type 33b of analysis of the measurement data stored in the first storage 10, and displays it as an option in the second selection field 51b.

The measurement data selection field 51c is a selection field in which the measurement data 30 (see FIG. 9) is selected.

The analyze button 51d is a GUI push button displayed on the screen 51 for performing the operation to request the analysis process of the measurement data 30. When the analyze button 51d is pressed, the input information 33 (see FIG. 9) and the measurement data 30 are transmitted from the data processor 2 to the server 1, and the analysis process of the measurement data 30 using the trained model 34 is started in the server 1.

The cancel button 51e is a GUI push button displayed on the screen 51 for performing the operation to request analysis process of the measurement data 30. When the cancel button 51e is pressed, the measurement data 30 is not transmitted to the server 1, the measurement data 30 is not analyzed in the server 1, and the screen 51 for performing the operation to request the analysis process of the measurement data 30 is closed.

In this embodiment, when the measurement data 30 is analyzed using the trained model 34 (see FIG. 2), the data processing program 41a (see FIG. 11) can also be used. The data processing program 41a is a program for performing a data process different from a data process of the trained model 34. Specifically, the data processing program 41a includes at least one of a program for preprocessing the measurement data 30 before analysis by the trained model 34 or a program for post-processing data after analysis by the trained model 34.

Therefore, for example, when the data processing program 41a includes a program for performing preprocessing, the measurement data 30 is preprocessed by the data processing program 41a by selecting the analysis conditions 42. Then, the preprocessed measurement data 30 is input to the trained model 34 to acquire the analysis result 31 (see FIG. 9). Furthermore, for example, when the data processing program 41a includes a program for performing postprocessing, by selecting the analysis condition 42, the measurement data 30 is input to the trained model 34 to acquire the analysis result 31. Then, the analysis result 31 is postprocessed by the data processing program 41a. When the data processing program 41a includes the program for performing the preprocessing and the program for performing the postprocessing, both the preprocessing of the measurement data 30 and the postprocessing of the analysis result 31 are performed.

As shown in FIG. 11, in this embodiment, the data processing program 41a is associated with the type 33a of measurement data 30 (see FIG. 9) and the type 33b of analysis of the measurement data 30 and is stored in advance in the first storage 10 (see FIG. 2) as the data processing program group 41. In this embodiment, the first storage 10 stores in advance a plurality of data processing program groups 41. That is, the first storage 10 stores the plurality of data processing program groups 41 as presets. That is, the first storage 10 stores in advance the plurality of data processing program groups 41 when manufacturing of the data analysis system 100 is completed.

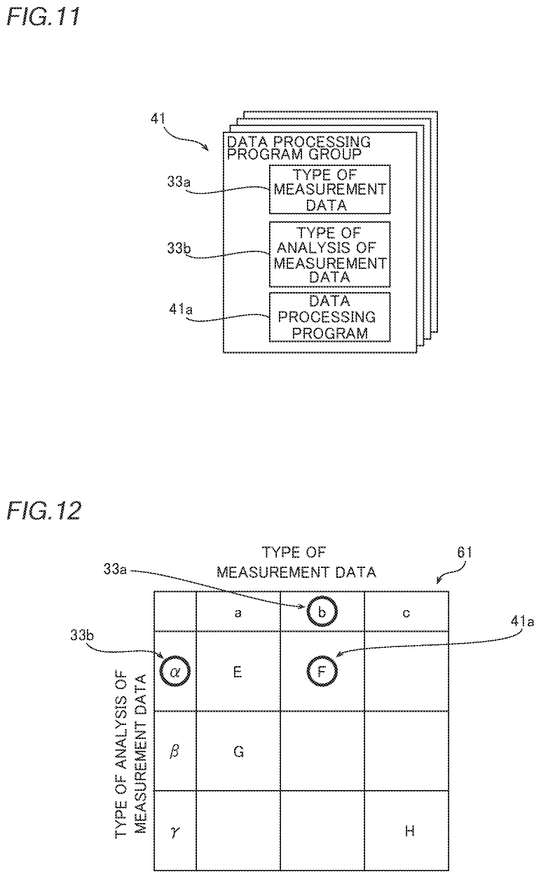

As shown in a matrix diagram 61 of FIG. 12, the data processing program group 41 is stored in which data processing programs 41a have been combined with the arbitrary combinations of the plurality of types 33a of measurement data 30 and the plurality of types 33b of analysis of the measurement data 30. For example, a data processing program 41a of “F” is associated with the combination in which the type 33a of measurement data 30 is “b” and the type 33b of analysis of the measurement data 30 is “a”. Therefore, the operator can select an appropriate data processing program 41a from among the plurality of data processing program groups 41 by selecting the type 33a of measurement data 30 and the type 33b of analysis of the measurement data 30. In an example shown in FIG. 12, in the matrix diagram 61, all combinations of the types 33a of measurement data 30 and the types 33b of analysis of the measurement data 30 are not associated with the data processing programs 41a. However, the first storage 10 may store the data processing programs 41a associated with all combinations of the types 33a of measurement data 30 and the types 33b of analysis of the measurement data 30.

In this embodiment, in addition to the previously stored (preset) data processing programs 41a, another data processing program 41a can be added. Specifically, the first processor 12 (see FIG. 2) receives addition of another data processing program 41a associated with the type 33a of measurement data 30 and the type 33b of analysis of the measurement data 30 to the data processing program groups 41 stored in advance. That is, the server 1 can add (plug in) another data processing program 41a to the plurality of data processing program groups 41 stored in advance.

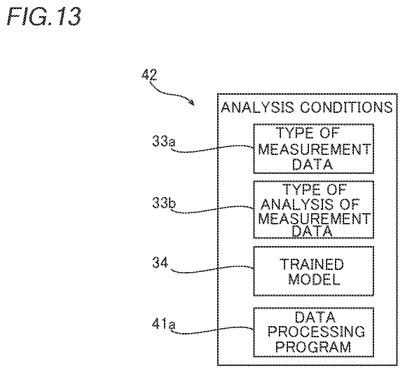

In this embodiment, the analysis result acquirer 12c (see FIG. 2) analyzes the measurement data 30 based on the analysis conditions 42 (see FIG. 13) and acquires the analysis result 31 (see FIG. 9).

As shown in FIG. 13, the analysis conditions 42 include the trained model 34 and the data processing program 41a. Specifically, the analysis conditions 42 in which the trained model 34, the data processing program 41a, the type 33a of measurement data 30 (see FIG. 9), and the type 33b of analysis of the measurement data 30 have been associated with each other are stored in the first storage 10 (see FIG. 2).

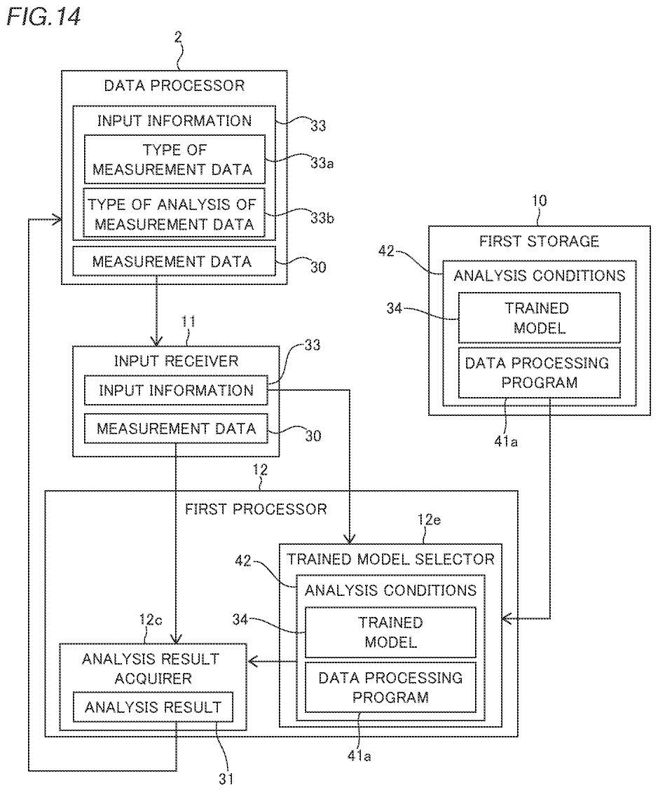

A configuration in which the first processor 12 acquires the analysis result 31 is now described with reference to FIG. 14.

As shown in FIG. 14, the input receiver 11 receives inputs of the input information 33 and the measurement data 30 from the data processor 2. The input receiver 11 outputs the input information 33 to the trained model selector 12e. Furthermore, the input receiver 11 outputs the measurement data 30 to the analysis result acquirer 12c.

The trained model selector 12e selects the trained model 34 based on the input information 33. Specifically, the trained model selector 12e selects the trained model 34 to be used to analyze the measurement data 30 based on the information about the type 33a of measurement data 30 and the information about the type 33b of analysis of the measurement data 30. In this embodiment, the trained model selector 12e selects one trained model 34 based on the information about the type 33a of measurement data 30 and the information about the type 33b of analysis of the measurement data 30.

In this embodiment, the trained model selector 12e also selects the data processing program 41a when selecting the trained model 34. That is, the trained model selector 12e selects the analysis conditions 42 including the trained model 34 and the data processing program 41a. The trained model selector 12e outputs the acquired trained model 34 and data processing program 41a (analysis conditions 42) to the analysis result acquirer 12c.

The analysis result acquirer 12c analyzes the measurement data 30 based on the trained model 34 and acquires the analysis result 31. In this embodiment, the analysis result acquirer 12c analyzes the measurement data 30 based on the trained model 34 generated by the trained model generator 12b and acquires the analysis result 31. Specifically, the analysis result acquirer 12c inputs the measurement data 30 to the trained model 34 selected by the trained model selector 12e and acquires the analysis result 31. In other words, the analysis result acquirer 12c acquires the analysis result 31 based on the selected analysis conditions 42. When acquiring the analysis result 31, the analysis result acquirer 12c performs a data process by the data processing program 41a according to the trained model 34. The analysis result acquirer 12c outputs the acquired analysis result 31 to the data processor 2.

The data processor 2 displays the acquired analysis result 31 on the display 23 (see FIG. 3).

### Data Analysis Process

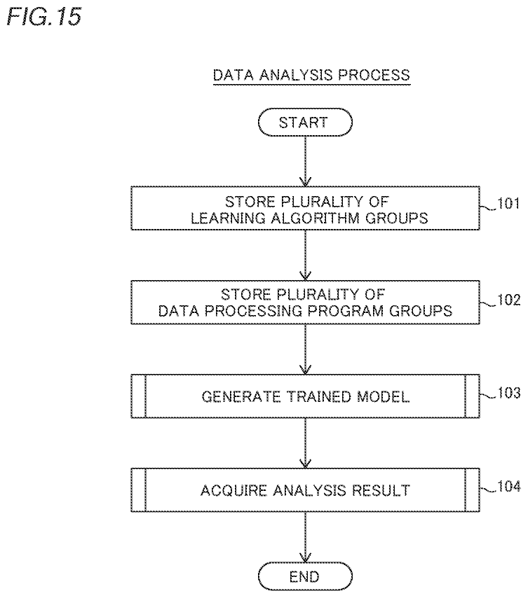

A data analysis process performed by the data analysis system 100 (see FIG. 1) according to this embodiment is now described with reference to FIG. 15.

In step 101, the server 1 (see FIG. 1) stores in advance the plurality of learning algorithm groups 40 (see FIG. 6) each including the type 33a (see FIG. 6) of measurement data 30 (see FIG. 1), the type 33b (see FIG. 6) of analysis of the measurement data 30, and the learning algorithm 40a (see FIG. 6) associated with each other.

In step 102, the server 1 stores in advance the plurality of data processing program groups 41 (see FIG. 11) each including the data processing program 41a (see FIG. 11) for performing a data process different from the data process of the trained model 34 (see FIG. 2), associated with the type 33a of measurement data 30 and the type 33b of analysis of the measurement data 30.

In step 103, the data analysis system 100 generates the trained model 34. The process in step 103 is described below in detail.

In step 104, the data analysis system 100 analyzes the measurement data 30 based on the trained model 34 and acquires the analysis result 31 (see FIG. 9). After that, the process is terminated. The process in step 104 is described below in detail.

In this embodiment, the process in step 101 and the process in step 102 are performed when the system management company manufactures the data analysis system 100. The process in step 103 and the process in step 104 are performed when the operator who is a customer uses the data analysis system 100.

### Trained Model Generation Process

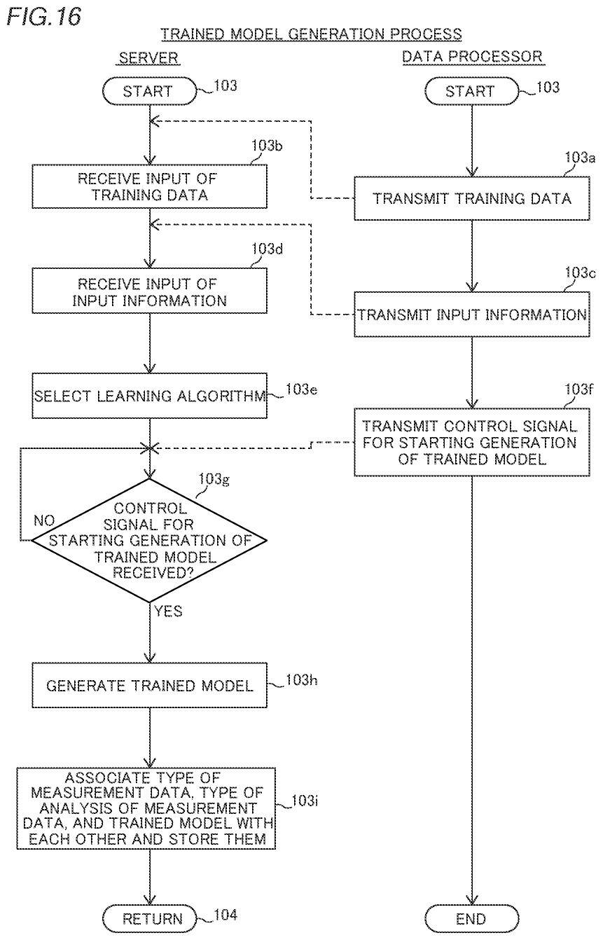

The process in which the data analysis system 100 (see FIG. 1) generates the trained model 34 (see FIG. 2) (the process in step 103 in FIG. 15) is now described with reference to FIG. 16. The process shown in FIG. 16 is started when the generate button 50d (see FIG. 5) is pressed on the screen 50 (see FIG. 5) for performing the process to generate the trained model 34.

In step 103a, the data processor 2 (see FIG. 4) transmits the training data 32 (see FIG. 8) to the server 1 (see FIG. 4).

In step 103b, the server 1 receives an input of the training data 32. The server 1 stores the received training data 32 in the first storage 10 (see FIG. 2).

In step 103c, the data processor 2 transmits the input information 33 (see FIG. 4) to the server 1.

In step 103d, the server 1 receives an input of the input information 33. Specifically, the server 1 receives an input of the input information 33 including the information about the type 33a (see FIG. 4) of measurement data 30 and the information about the type 33b (see FIG. 4) of analysis of the measurement data 30.

In step 103e, the learning algorithm selector 12a (see FIG. 8) selects the learning algorithm 40a (see FIG. 8) to be used for learning from among the plurality of learning algorithm groups 40 (see FIG. 8) based on the input information 33. That is, when the operator inputs the input information 33, the learning algorithm 40a suitable for learning is automatically selected.

In step 103f, the data processor 2 transmits a control signal for starting generation of the trained model 34 to the server 1. After that, the process in the data processor 2 is terminated. When the process in step 103f is performed, the second processor 21 (see FIG. 3) displays the learning algorithm 40a selected in step 103e on the display 23 (see FIG. 3). Thus, the user can confirm the selected learning algorithm 40a and perform an operation to start generation of the trained model 34.

In step 103g, the server 1 determines whether or not the control signal for starting generation of the trained model 34 has been received. When determining that the control signal for starting generation of the trained model 34 has not been received, the server 1 repeats the process in step 103g. When the server 1 determines that the control signal for starting generation of the trained model 34 has been received, the process advances to step 103h.

In step 103h, the trained model generator 12b (see FIG. 8) generates the trained model 34 based on the training data 32 and the selected learning algorithm 40a.

In step 103i, the trained model storage controller 12d associates the type 33a of measurement data 30, the type 33b of analysis of the measurement data 30, and the trained model 34 with each other, and stores them in the first storage 10 (see FIG. 8). After that, the process advances to the process in step 104 (see FIG. 15), and the process to generate the trained model 34 is terminated.

### Analysis Result Acquisition Process

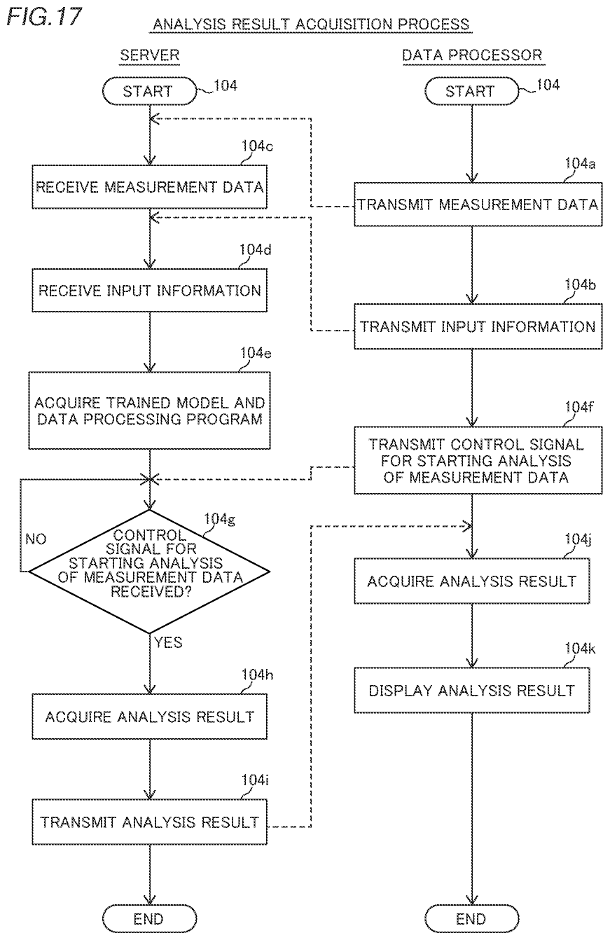

The process in which the data analysis system 100 (see FIG. 1) analyzes the measurement data 30 (see FIG. 14) and acquires the analysis result 31 (see FIG. 14) (the process in step 104 shown in FIG. 15) is now described with reference to FIG. 17. The process shown in FIG. 17 is started when the analyze button 51d (see FIG. 10) is pressed on the screen 51 (see FIG. 10) for performing the operation to request the analysis process of the measurement data 30.

In step 104a, the data processor 2 (see FIG. 9) transmits the measurement data 30 (see FIG. 9) to the server 1.

In step 104b, the data processor 2 transmits the input information 33 (see FIG. 9) to the server 1. Either the process in step 104a or the process in step 104b may be performed first.

In step 104c, the server 1 receives the measurement data 30. That is, the server 1 receives the measurement data 30 acquired by the measuring device 3. The process in step 104c may be performed prior to the process in step 104b after the process in step 104a is performed.

In step 104d, the server 1 receives the input information 33. That is, the server 1 receives the information about the type 33a (see FIG. 9) of measurement data 30 and the information about the type 33b (see FIG. 9) of analysis of the measurement data 30. In other words, the server 1 receives an operation input to select the analysis conditions 42 (see FIG. 13). The process in step 104d may be performed prior to the process in step 104c after the process in step 104b is performed.

In step 104e, the trained model selector 12e (see FIG. 14) selects the trained model 34 (see FIG. 14) based on the input information 33. In this embodiment, in step 104e, the trained model selector 12e selects the data processing program 41a (see FIG. 14) together with the trained model 34 based on the input information 33. That is, the trained model selector 12e selects the analysis conditions 42 based on the input information 33. Therefore, when the operator inputs the input information 33, the analysis conditions 42 suitable for analyzing the measurement data 30 are automatically selected.

In step 104f, the data processor 2 transmits a control signal for starting analysis of the measurement data 30 to the server 1. When the process in step 104f is performed, the second processor 21 (see FIG. 3) displays the analysis conditions 42 selected in step 104e on the display 23 (see FIG. 3). Thus, the user can confirm the selected analysis conditions 42 and perform an operation to start the analysis of the measurement data 30.

In step 104g, the first processor 12 (see FIG. 14) determines whether or not the control signal for starting analysis of the measurement data 30 has been received. When determining that the control signal for starting analysis of the measurement data 30 has not been received, the first processor 12 repeats the process in step 104g. When the first processor 12 determines that the control signal for starting analysis of the measurement data 30 has been received, the process advances to step 104h.

In step 104h, the analysis result acquirer 12c (see FIG. 14) analyzes the measurement data 30 based on the trained model 34 and acquires the analysis result 31. In this embodiment, the analysis result acquirer 12c inputs the measurement data 30 to the trained model 34 selected by the trained model selector 12e and acquires the analysis result 31. That is, the analysis result acquirer 12c acquires the analysis result 31 based on the analysis conditions 42 selected by the trained model selector 12e.

In step 104i, the first processor 12 transmits the analysis result 31 to the data processor 2. After that, the process in which the server 1 acquires the analysis result 31 is terminated.

In step 104j, the data processor 2 acquires the analysis result 31.

In step 104k, the data processor 2 (second processor 21) displays the analysis result 31 on the display 23 (see FIG. 3). After that, the process is terminated.

### Learning Algorithm Addition Process

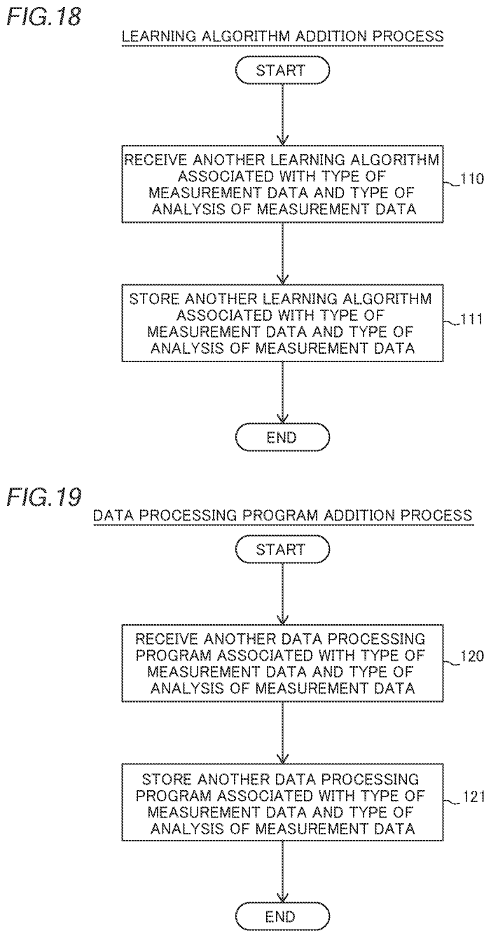

A process in which the server 1 (see FIG. 1) adds the learning algorithm 40a (see FIG. 6) is now described with reference to FIG. 18.

In step 110, the first processor 12 (see FIG. 2) receives addition of another learning algorithm 40a associated with the type 33a (see FIG. 6) of measurement data 30 (see FIG. 1) and the type 33b (see FIG. 6) of analysis of the measurement data 30 to the plurality of learning algorithm groups 40 (see FIG. 6) stored in advance.

In step 111, the first processor 12 stores another learning algorithm 40a associated with the type 33a of measurement data 30 and the type 33b of analysis of the measurement data 30 in the first storage 10 (see FIG. 2). After that, the process is terminated. The learning algorithm 40a stored in step 111 is a learning algorithm 40a in which the type 33a of measurement data 30 and the type 33b of analysis of the measurement data 30 associated therewith are different from those of the learning algorithm 40a already stored as the learning algorithm group 40. Even when the type of learning algorithm 40a is the same, the learning algorithm 40a can be added to the learning algorithm groups 40 when at least one of the type 33a of measurement data 30 or the type 33b of analysis of the measurement data 30 is different.

### Data Processing Program Addition Process

A process in which the server 1 (see FIG. 1) adds the data processing program 41a (see FIG. 11) is now described with reference to FIG. 19.

In step 120, the first processor 12 (see FIG. 2) receives addition of another data processing program 41a associated with the type 33a (see FIG. 11) of measurement data 30 (see FIG. 1) and the type 33b (see FIG. 11) of analysis of the measurement data 30 to the data processing program groups 41 (see FIG. 11) stored in advance.

In step 121, the first processor 12 stores another data processing program 41a associated with the type 33a of measurement data 30 and the type 33b of analysis of the measurement data 30 in the first storage 10 (see FIG. 2). After that, the process is terminated. The data processing program 41a stored in step 121 is a data processing program 41a in which the type 33a of measurement data 30 and the type 33b of analysis of the measurement data 30 associated therewith are different from those of the data processing program 41a already stored as the data processing program group 41. Even when the type of data processing program 41a is the same, the data processing program 41a can be added to the data processing program groups 41 when at least one of the type 33a of measurement data 30 or the type 33b of analysis of the measurement data 30 is different.

### Advantages of this Embodiment

According to this embodiment, the following advantages are obtained.

According to the embodiment described above, the data analysis method is a data analysis method implemented between the system management company and the customer who desires to acquire the analysis result 31 of the measurement data 30 acquired from the measuring device 3, and includes the storage step of storing in advance the plurality of learning algorithm groups 40 each including the type 33a of measurement data 30, the type 33b of analysis of the measurement data 30, and the learning algorithm 40a associated with each other, the training data receiving step of receiving an input of the training data 32, the input information receiving step of receiving an input of the input information 33 including the information about the type 33a of measurement data 30 and the information about the type 33b of analysis of the measurement data 30, the learning algorithm selection step of selecting the learning algorithm 40a to be used for learning from among the plurality of learning algorithm groups 40 based on the input information 33, the trained model generation step of generating the trained model 34 based on the training data 32 and the selected learning algorithm 40a, and the analysis result acquisition step of analyzing the measurement data 30 based on the trained model 34 and acquiring the analysis result 31.

Accordingly, the user simply inputs the information about the type 33a of measurement data 30 and the information about the type 33b of analysis of the measurement data 30 such that the learning algorithm 40a suitable for the trained model 34 to be used to analyze the measurement data 30 is selected from among the plurality of learning algorithm groups 40. Therefore, even the user with low skills can easily generate the trained model 34 without outsourcing the generation. Moreover, the trained model 34 can be generated without being outsourced, and thus the time required to generate the trained model 34 can be reduced. Consequently, it is possible to provide the data analysis method that enables even the user with low skills to easily generate the trained model 34 and can reduce the time required to analyze the measurement data 30 using the trained model 34.

According to the embodiment described above, the data analysis system 100 is a data analysis system configured to perform data analysis between the system management company and the customer who desires to acquire the analysis result 31 of the measurement data 30 acquired from the measuring device 3, and includes the server 1 configured to generate the trained model 34 to analyze the measurement data 30, and the data processor 2 configured to request the server 1 to analyze the measurement data 30. The server 1 includes the first storage 10 configured to store in advance the plurality of learning algorithm groups 40 each including the type 33a of measurement data 30, the type 33b of analysis of the measurement data 30, and the learning algorithm 40a associated with each other, the input receiver 11 configured to receive an input of the input information 33 including the information about the type 33a of measurement data 30 and the information about the type 33b of analysis of the measurement data 30, and an input of the training data 32, the learning algorithm selector 12a configured to select the learning algorithm 40a to be used for learning from among the plurality of learning algorithm groups 40 based on the input information 33, the trained model generator 12b configured to generate the trained model 34 based on the training data 32 and the selected learning algorithm 40a, and the analysis result acquirer 12c configured to analyze the measurement data 30 based on the trained model 34 generated by the trained model generator 12b and acquire the analysis result 31.

Accordingly, it is possible to provide the data analysis system 100 that enables even the user with low skills to easily generate the trained model 34 and can reduce the time required to analyze the measurement data 30 using the trained model 34, similarly to the data analysis method described above.

According to the embodiment described above, the data analysis system server 1 is a data analysis system server configured to perform data analysis between the system management company and the customer who desires to acquire the analysis result 31 of the measurement data 30 acquired from the measuring device 3, and includes the first storage 10 configured to store in advance the plurality of learning algorithm groups 40 each including the type 33a of measurement data 30, the type 33b of analysis of the measurement data 30, and the learning algorithm 40a associated with each other, the input receiver 11 configured to receive an input of the input information 33 including the information about the type 33a of measurement data 30 and the information about the type 33b of analysis of the measurement data 30, and an input of the training data 32, the learning algorithm selector 12a configured to select the learning algorithm 40a to be used for learning from among the plurality of learning algorithm groups 40 based on the input information 33, the trained model generator 12b configured to generate the trained model 34 based on the training data 32 and the selected learning algorithm 40a, and the analysis result acquirer 12c configured to analyze the measurement data 30 based on the trained model 34 generated by the trained model generator 12b and acquire the analysis result 31.

Accordingly, it is possible to provide the data analysis system server 1 that enables even the user with low skills to easily generate the trained model 34 and can reduce the time required to analyze the measurement data 30 using the trained model 34, similarly to the data analysis method described above.

In the embodiment described above, with the following configurations, the following advantages are further obtained.

That is, according to this embodiment, as described above, in the learning algorithm selection step, the learning algorithm 40a corresponding to the information about the type 33a of measurement data 30 and the information about the type 33b of analysis of the measurement data 30 is selected from among the plurality of learning algorithm groups 40. Accordingly, the learning algorithm 40a corresponding to the type 33a of measurement data 30 and the type 33b of analysis of the measurement data 30 is selected from among the plurality of learning algorithm groups 40, and thus even when the user does not know much about the learning algorithm 40a, the trained model 34 can be easily created using the learning algorithm 40a suitable for creating the trained model 34 to be used to analyze the measurement data 30. Consequently, even the user with low skills can easily generate the trained model 34 suitable for analyzing the measurement data 30.

According to this embodiment, as described above, the data analysis method further includes the trained model storage step of storing, in association with each other, the trained model 34 generated in the trained model generation step, and the type 33a of measurement data 30 and the type 33b of analysis of the measurement data 30, both of which are received in the input information receiving step, the analysis receiving step of receiving the information about the type 33a of measurement data 30, the information about the type 33b of analysis of the measurement data 30, and the measurement data 30 acquired by the measuring device 3, and the trained model selection step of selecting the trained model 34 to be used to analyze the measurement data 30 based on the information about the type 33a of measurement data 30 and the information about the type 33b of analysis of the measurement data 30 received in the analysis receiving step. In the analysis result acquisition step, the measurement data 30 is input to the trained model 34 selected in the trained model selection step, and the analysis result 31 is acquired. Accordingly, the generated trained model 34 is stored in association with the type 33a of measurement data 30 and the type 33b of analysis of the measurement data 30, and thus when the measurement data 30 is analyzed using the generated trained model 34, the trained model 34 suitable for analyzing the measurement data 30 can be easily selected based on the information about the type 33a of measurement data 30 and the information about the type 33b of analysis of the measurement data 30. Consequently, even the user with low skills can easily analyze the measurement data 30 using the generated trained model 34, and thus user convenience (usability) can be improved.

According to this embodiment, as described above, the data analysis method further includes the data processing program storage step of storing in advance the plurality of data processing program groups 41 each including the data processing program 41a configured to perform the data process different from the data process of the trained model 34 and associated with the type 33a of measurement data 30 and the type 33b of analysis of the measurement data 30. In the analysis receiving step, an operation input is further received to select the analysis conditions 42 including the trained model 34 and the data processing program 41a, and in the analysis result acquisition step, the analysis result 31 is acquired based on the selected analysis conditions 42. Accordingly, the data processing program 41a is included together with the trained model 34 in the analysis conditions 42, and thus the measurement data 30 can be analyzed by the data processing program 41a for performing the process necessary for analysis by the trained model 34, for example. Consequently, the accuracy of the analysis result 31 of the measurement data 30 can be improved as compared with a configuration in which the measurement data 30 is analyzed using only the trained model 34.

According to this embodiment, as described above, the data analysis method further includes the data processing program addition receiving step of receiving addition of another data processing program 41a associated with the type 33a of measurement data 30 and the type 33b of analysis of the measurement data 30 to the plurality of data processing program groups 41 stored in advance. Accordingly, when the user desires to perform analysis using a data processing program 41a other than the data processing programs 41a stored in advance, the data processing program 41a can be easily added as compared with a configuration in which the entire system is updated, for example. Consequently, the data processing program 41a desired by the user can be easily added, and thus the function of the data processing program 41a in analyzing the measurement data 30 can be easily expanded.

According to this embodiment, as described above, the data analysis method further includes the learning algorithm addition receiving step of receiving addition of another learning algorithm 40a associated with the type 33a of measurement data 30 and the type 33b of analysis of the measurement data 30 to the plurality of learning algorithm groups 40 stored in advance. Accordingly, when the user desires to generate the trained model 34 using a learning algorithm 40a other than the learning algorithms 40a stored in advance, the learning algorithm 40a can be easily added as compared with the configuration in which the entire system is updated. Consequently, the learning algorithm 40a desired by the user can be easily added, and thus the function for generating the trained model 34 suitable for analyzing the measurement data 30 can be easily expanded.

### Modified Examples

The embodiment disclosed this time must be considered as illustrative in all points and not restrictive. The scope of the present invention is not shown by the above description of the embodiment but by the scope of claims for patent, and all modifications (modified examples) within the meaning and scope equivalent to the scope of claims for patent are further included.

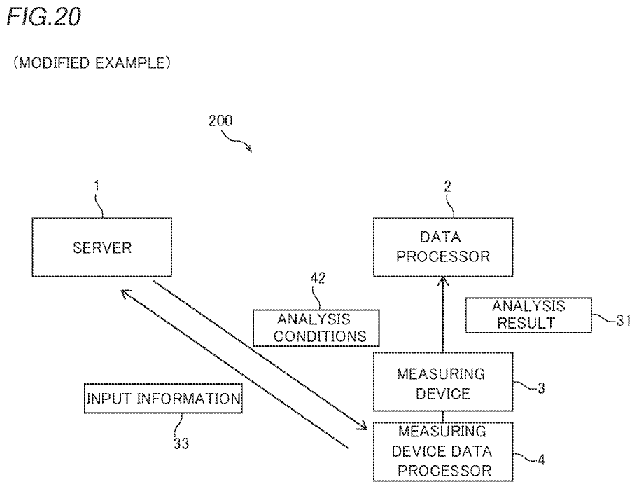

For example, while the data analysis system 100 analyzes the measurement data 30 by the server 1 in the aforementioned embodiment, the present invention is not limited to this. For example, as in a data analysis system 200 according to a modified example shown in FIG. 20, the measurement data 30 may alternatively be analyzed by other than the server 1. The data analysis system 200 according to the modified example shown in FIG. 20 differs from the data analysis system 100 according to the aforementioned embodiment in that the data analysis system 200 includes a measuring device data processor 4.

The measuring device data processor 4 is configured to control the measuring device 3. The measuring device data processor 4 is connected to the server 1. The measuring device data processor 4 is also configured to analyze the measurement data 30.

As shown in FIG. 20, the measuring device data processor 4 according to the modified example is configured to transmit the input information 33 to the server 1. The server 1 that has received the input information 33 from the measuring device data processor 4 selects the analysis conditions 42. The configuration in which the server 1 selects the analysis conditions 42 is similar to the configuration according to the aforementioned embodiment, and thus detailed description thereof is omitted. The server 1 transmits the selected analysis conditions 42 to the measuring device data processor 4.

Upon receiving the analysis conditions 42, the measuring device data processor 4 analyzes the measurement data 30 based on the analysis conditions 42 and acquires analysis result 31. The measuring device data processor 4 transmits the acquired analysis result 31 to the data processor 2. Thus, the analysis result 31 can be displayed on the data processor 2. The configuration in which the measuring device data processor 4 acquires the analysis result 31 is similar to the configuration in which the analysis result acquirer 12c according to the aforementioned embodiment acquires the analysis result 31, and thus detailed description thereof is omitted.

While the learning algorithm selector 12a selects one learning algorithm 40a corresponding to the type 33a of measurement data 30 and the type 33b of analysis of the measurement data 30 in the aforementioned embodiment, the present invention is not limited to this. For example, the learning algorithm selector 12a may alternatively select a plurality of candidate learning algorithms 40a from among the learning algorithm groups 40 based on the type 33a of measurement data 30 and the type 33b of analysis of the measurement data 30. With this configuration, the plurality of candidate learning algorithms 40a can be displayed on the display 23. Consequently, the operator can select a plurality of learning algorithms 40a, and thus the degree of freedom in selecting the learning algorithms 40a can be improved.

While the trained model selector 12e selects one trained model 34 based on the type 33a of measurement data 30 and the type 33b of analysis of the measurement data 30 in the aforementioned embodiment, the present invention is not limited to this. For example, the trained model selector 12e may alternatively select a plurality of candidate trained models 34 based on the type 33a of measurement data 30 and the type 33b of analysis of the measurement data 30. With this configuration, the plurality of candidate trained models 34 can be displayed on the display 23, and thus the degree of freedom in selecting the trained models 34 can be improved.

While the first storage 10 stores in advance the data processing program groups 41 in the aforementioned embodiment, the present invention is not limited to this. The first storage 10 may not store in advance the data processing program groups 41. In this case, when the operator analyzes the measurement data 30, the data processing program 41a may be input. However, when the operator inputs the data processing program 41a each time the measurement data 30 is analyzed, the operation becomes complex, and the burden on the operator increases. Therefore, the first storage 10 preferably stores in advance the data processing program groups 41.

While the server 1 can add the data processing program 41a to the data processing program groups 41 in the aforementioned embodiment, the present invention is not limited to this. For example, the server 1 may not be able to add the data processing program 41a to the data processing program groups 41. However, when the server 1 cannot add the data processing program 41a to the data processing program groups 41, it becomes difficult to easily add the data processing program 41a desired by the user, and user convenience (usability) decreases. Therefore, it is preferable that the server 1 can add the data processing program 41a to the data processing program groups 41.

While the first processor 12 receives addition of another learning algorithm 40a associated with the type 33a of measurement data 30 and the type 33b of analysis of the measurement data 30 to the learning algorithm groups 40 stored in advance in the aforementioned embodiment, the present invention is not limited to this. For example, the first processor 12 may alternatively individually receive an input of the type 33a of measurement data 30, an input of the type 33b of analysis of the measurement data 30, and an input of another learning algorithm 40a. In this case, the first processor 12 is only required to associate the type 33a of measurement data 30 and the type 33b of analysis of the measurement data 30 with another learning algorithm 40a and store them in the first storage 10.

While the server 1 can add the learning algorithm 40a to the learning algorithm groups 40 in the aforementioned embodiment, the present invention is not limited to this. For example, the server 1 may not be able to add the learning algorithm 40a to the learning algorithm groups 40. However, when the server 1 cannot add the learning algorithm 40a to the learning algorithm groups 40, it becomes difficult to easily add the learning algorithm 40a desired by the user, and user convenience (usability) decreases. Therefore, it is preferable that the server 1 can add the learning algorithm 40a to the learning algorithm groups 40.

While the first processor 12 receives addition of another data processing program 41a associated with the type 33a of measurement data 30 and the type 33b of analysis of the measurement data 30 to the data processing program groups 41 stored in advance in the aforementioned embodiment, the present invention is not limited to this. For example, the first processor 12 may alternatively individually receive an input of the type 33a of measurement data 30, an input of the type 33b of analysis of the measurement data 30, and an input of another data processing program 41a. In this case, the first processor 12 is only required to associate the type 33a of measurement data 30 and the type 33b of analysis of the measurement data 30 with another data processing program 41a and store them in the first storage 10.

While the first processor 12 receives an input of the training data 32 at the timing different from the timing at which an input of the input information 33 is received and stores the training data 32 and the input information 33 in the first storage 10 in the aforementioned embodiment, the present invention is not limited to this. For example, the training data 32 may alternatively be input to the server 1 together with the input information 33. That is, the first processor 12 may generate the trained model 34 based on the training data 32 input together with the input information 33.

While the data analysis process, the process to generate the trained model 34, the process to acquire the analysis result 31 of the measurement data 30, the process to add the learning algorithm 40a, and the process to add the data processing program 41a are described using flowcharts in a flow-driven manner in which processes are performed in order along a process flow for the convenience of illustration in the aforementioned embodiment, the present invention is not limited to this. In the present invention, the process operations may alternatively be performed in an event-driven manner in which the processes are performed on an event basis. In this case, the process operations may be performed in a complete event-driven manner or in a combination of an event-driven manner and a flow-driven manner.

### Aspects

It will be appreciated by those skilled in the art that the exemplary embodiments described above are specific examples of the following aspects.

### (Item 1)

A data analysis method implemented between a system management company and a customer who desires to acquire an analysis result of measurement data acquired from a measuring device, the data analysis method comprising:
a storage step of storing in advance a plurality of learning algorithm groups each including a type of the measurement data, a type of analysis of the measurement data, and a learning algorithm associated with each other;
a training data receiving step of receiving an input of training data;
an input information receiving step of receiving an input of input information including information about the type of the measurement data and information about the type of analysis of the measurement data;
a learning algorithm selection step of selecting the learning algorithm to be used for learning from among the plurality of learning algorithm groups based on the input information;
a trained model generation step of generating a trained model based on the training data and the selected learning algorithm; and
an analysis result acquisition step of analyzing the measurement data based on the trained model and acquiring the analysis result.

### (Item 2)

The data analysis method according to item 1, wherein in the learning algorithm selection step, the learning algorithm corresponding to information about the type of the measurement data and information about the type of analysis of the measurement data is selected from among the plurality of learning algorithm groups.

### (Item 3)

The data analysis method according to item 2, further comprising:
a trained model storage step of storing, in association with each other, the trained model generated in the trained model generation step, and the type of the measurement data and the type of analysis of the measurement data, both of which are received in the input information receiving step;
an analysis receiving step of receiving the information about the type of the measurement data, the information about the type of analysis of the measurement data, and the measurement data acquired by the measuring device; and
a trained model selection step of selecting the trained model to be used to analyze the measurement data based on the information about the type of the measurement data and the information about the type of analysis of the measurement data received in the analysis receiving step; wherein
in the analysis result acquisition step, the measurement data is input to the trained model selected in the trained model selection step, and the analysis result is acquired.

### (Item 4)

The data analysis method according to item 3, further comprising:
a data processing program storage step of storing in advance a plurality of data processing program groups each including a data processing program configured to perform a data process different from a data process of the trained model, the data processing program being associated with the type of the measurement data and the type of analysis of the measurement data; wherein
in the analysis receiving step, an operation input is further received to select analysis conditions including the trained model and the data processing program; and
in the analysis result acquisition step, the analysis result is acquired based on the selected analysis conditions.

### (Item 5)

The data analysis method according to item 4, further comprising:
a data processing program addition receiving step of receiving addition of another data processing program associated with the type of the measurement data and the type of analysis of the measurement data to the plurality of data processing program groups stored in advance.

### (Item 6)

The data analysis method according to item 1, further comprising:
a learning algorithm addition receiving step of receiving addition of another learning algorithm associated with the type of the measurement data and the type of analysis of the measurement data to the plurality of learning algorithm groups stored in advance.

### (Item 7)

A data analysis system configured to perform data analysis between a system management company and a customer who desires to acquire an analysis result of measurement data acquired from a measuring device, the data analysis system comprising:
a server configured to generate a trained model to analyze the measurement data; and
a data processor configured to request the server to analyze the measurement data; wherein
the server includes:
   a storage configured to store in advance a plurality of learning algorithm groups each including a type of the measurement data, a type of analysis of the measurement data, and a learning algorithm associated with each other;
   an input receiver configured to receive an input of input information including information about the type of the measurement data and information about the type of analysis of the measurement data, and an input of training data;
   a learning algorithm selector configured to select the learning algorithm to be used for learning from among the plurality of learning algorithm groups based on the input information;
   a trained model generator configured to generate the trained model based on the training data and the selected learning algorithm; and
   an analysis result acquirer configured to analyze the measurement data based on the trained model generated by the trained model generator and acquire the analysis result.

### (Item 8)

A data analysis system server configured to perform data analysis between a system management company and a customer who desires to acquire an analysis result of measurement data acquired from a measuring device, the data analysis system server comprising:
a storage configured to store in advance a plurality of learning algorithm groups each including a type of the measurement data, a type of analysis of the measurement data, and a learning algorithm associated with each other;
an input receiver configured to receive an input of input information including information about the type of the measurement data and information about the type of analysis of the measurement data, and an input of training data;
a learning algorithm selector configured to select the learning algorithm to be used for learning from among the plurality of learning algorithm groups based on the input information;
a trained model generator configured to generate the trained model based on the training data and the selected learning algorithm; and
an analysis result acquirer configured to analyze the measurement data based on the trained model generated by the trained model generator and acquire the analysis result.

What is claimed is:

1. A data analysis method implemented between a system management company and a customer who desires to acquire an analysis result of measurement data acquired from a measuring device, the data analysis method comprising:
a storage step of storing in advance a plurality of learning algorithm groups each including a type of the measurement data, a type of analysis of the measurement data, and a learning algorithm associated with each other;
a training data receiving step of receiving an input of training data;
an input information receiving step of receiving an input of input information including information about the type of the measurement data and information about the type of analysis of the measurement data;
a learning algorithm selection step of selecting the learning algorithm to be used for learning from among the plurality of learning algorithm groups based on the input information;
a trained model generation step of generating a trained model based on the training data and the selected learning algorithm; and
an analysis result acquisition step of analyzing the measurement data based on the trained model and acquiring the analysis result.

2. The data analysis method according to claim 1, wherein in the learning algorithm selection step, the learning algorithm corresponding to information about the type of the measurement data and information about the type of analysis of the measurement data is selected from among the plurality of learning algorithm groups.

3. The data analysis method according to claim 2, further comprising:
a trained model storage step of storing, in association with each other, the trained model generated in the trained model generation step, and the type of the measurement data and the type of analysis of the measurement data, both of which are received in the input information receiving step;
an analysis receiving step of receiving the information about the type of the measurement data, the information about the type of analysis of the measurement data, and the measurement data acquired by the measuring device; and
a trained model selection step of selecting the trained model to be used to analyze the measurement data based on the information about the type of the measurement data and the information about the type of analysis of the measurement data received in the analysis receiving step; wherein
in the analysis result acquisition step, the measurement data is input to the trained model selected in the trained model selection step, and the analysis result is acquired.

4. The data analysis method according to claim 3, further comprising:
a data processing program storage step of storing in advance a plurality of data processing program groups each including a data processing program configured to perform a data process different from a data process of the trained model, the data processing program being associated with the type of the measurement data and the type of analysis of the measurement data; wherein
in the analysis receiving step, an operation input is further received to select analysis conditions including the trained model and the data processing program; and
in the analysis result acquisition step, the analysis result is acquired based on the selected analysis conditions.

5. The data analysis method according to claim 4, further comprising:
a data processing program addition receiving step of receiving addition of another data processing program associated with the type of the measurement data and the type of analysis of the measurement data to the plurality of data processing program groups stored in advance.

6. The data analysis method according to claim 1, further comprising:
a learning algorithm addition receiving step of receiving addition of another learning algorithm associated with the type of the measurement data and the type of analysis of the measurement data to the plurality of learning algorithm groups stored in advance.

7. A data analysis system configured to perform data analysis between a system management company and a customer who desires to acquire an analysis result of measurement data acquired from a measuring device, the data analysis system comprising:
a server configured to generate a trained model to analyze the measurement data; and
a data processor configured to request the server to analyze the measurement data; wherein
the server includes:
a storage configured to store in advance a plurality of learning algorithm groups each including a type of the measurement data, a type of analysis of the measurement data, and a learning algorithm associated with each other;
an input receiver configured to receive an input of input information including information about the type of the measurement data and information about the type of analysis of the measurement data, and an input of training data;
a learning algorithm selector configured to select the learning algorithm to be used for learning from among the plurality of learning algorithm groups based on the input information;
a trained model generator configured to generate the trained model based on the training data and the selected learning algorithm; and
an analysis result acquirer configured to analyze the measurement data based on the trained model generated by the trained model generator and acquire the analysis result.

8. A data analysis system server configured to perform data analysis between a system management company and a customer who desires to acquire an analysis result of measurement data acquired from a measuring device, the data analysis system server comprising:
a storage configured to store in advance a plurality of learning algorithm groups each including a type of the measurement data, a type of analysis of the measurement data, and a learning algorithm associated with each other;
an input receiver configured to receive an input of input information including information about the type of the measurement data and information about the type of analysis of the measurement data, and an input of training data;
a learning algorithm selector configured to select the learning algorithm to be used for learning from among the plurality of learning algorithm groups based on the input information;
a trained model generator configured to generate the trained model based on the training data and the selected learning algorithm; and
an analysis result acquirer configured to analyze the measurement data based on the trained model generated by the trained model generator and acquire the analysis result.
